(19) United States
(12) Patent Application Publication
(10) Pub. No.: US 2025/0266758 A1
(43) Pub. Date: Aug. 21, 2025

(54) POWER CONVERSION CIRCUIT AUTOMATICALLY SWITCHING BETWEEN FLYBACK MODE AND RESONANT MODE AND CONTROL METHOD THEREOF

(71) Applicant: Richtek Technology Corporation, Zhubei City (TW)

(72) Inventor: Kuo-Chi LIU, Hsinchu City (TW)

(21) Appl. No.: 18/792,930

(22) Filed: Aug. 2, 2024

Related U.S. Application Data
(60) Provisional application No. 63/555,471, filed on Feb. 20, 2024.

(30) Foreign Application Priority Data
Jul. 3, 2024 (TW) 113124929

(51) Int. Cl. H02M 3/00; H02M 3/335

(52) U.S. Cl. CPC H02M 3/01; H02M 3/33576

(57) ABSTRACT

A power convertor includes a resonant capacitor, a transformer, a high-side transistor, a low-side transistor, a control circuit, and a rectifying circuit. The resonant capacitor is coupled between a resonant node and a ground. The transformer includes a primary coil coupled between a switch node and the resonant node and a secondary coil. The high-side transistor provides an input voltage to the switch node and the low-side transistor couples the switch node to the ground. The control circuit operates in either one of a flyback mode and a non-flyback mode, and drives the high-side transistor and the low-side transistor. When the control circuit operates in the resonant mode, the rectifying circuit full-wave rectifies the energy of the secondary coil to generate the output voltage.

### CROSS REFERENCE TO RELATED APPLICATIONS

This application claims the benefit of U.S. Provisional Application No. 63/555,471, filed on Feb. 20, 2024, the entirety of which is incorporated by reference herein.

This application claims priority of Taiwan Patent Application No. 113124929, filed on Jul. 3, 2024, the entirety of which is incorporated by reference herein.

### BACKGROUND OF THE INVENTION

### Field of the Invention

The disclosure is generally related to a power conversion circuit and a control method thereof, and more particularly it is related to a power conversion circuit that automatically switches between a flyback mode and a resonant mode and a control method thereof.

### Description of the Related Art

With the continuous advancements being made in portable electronic devices, the development of power conversion circuits, like most power products, is trending in the direction of high efficiency, high power density, high reliability, and low cost. Since the resonant power convertor (including LLC resonant power convertor, etc.) has the advantages of achieving zero-voltage switching (ZVS) on the primary side and zero-current switching (ZCS) of the rectifier diode on the secondary side within the full load range, causing the duty cycle of the high-side and low-side transistors to both be 50% by frequency control, no output inductor required, using low-voltage transistors on the secondary side leading to cost reductions and efficiency improvements, the resonant power convertor has been increasingly used for DC voltage conversion in recent years.

However, due to the circuit characteristics of the resonant power conversion circuit, a higher switching frequency must be used when the output voltage is low or the load is light, resulting in poor conversion efficiency of the resonant power conversion circuit. In order to meet the current market demand for a wide range of output voltage, high output power and high conversion efficiency, it is necessary to further optimize the power conversion circuit.

### BRIEF SUMMARY OF THE INVENTION

A power conversion circuit and a control method thereof have been proposed herein, so that the power conversion circuit automatically switches between the resonant mode and the flyback mode. When the power conversion circuit operates in the resonant mode and determines that the switching frequency exceeds a predetermined frequency, the power conversion circuit switches to the flyback mode to reduce the switching frequency, so as to obtain higher conversion efficiency. When the power conversion circuit operates in the flyback mode and determines that the duty cycle of the high-side transistor exceeds the predetermined duty cycle, the power conversion circuit switches to the resonant mode to provide greater output power. Therefore, the power conversion circuit and the control method thereof proposed herein can not only provide a wide range of output voltage and high output power, but also maintain high conversion efficiency at light load and low output voltage, helping to meet market demand.

In an embodiment, a power conversion circuit converting an input voltage into an output voltage is provided. The power conversion circuit comprises a resonant capacitor, a transformer, a high-side transistor, a low-side transistor, a control circuit, and a rectifying circuit. The resonant capacitor is coupled between a resonant node and a ground. The transformer comprises a primary coil and a secondary coil, wherein the primary coil is coupled between a switch node and the resonant node. The high-side transistor provides the input voltage to the switch node based on a high-side driving signal. The low-side transistor couples the switch node to the ground based on a low-side driving signal. The control circuit operates in either a flyback mode or a resonant mode to generate the high-side driving signal and the low-side driving signal. The rectifying circuit converts energy of the secondary coil into the output voltage. When the control circuit operates in the resonant mode, the rectifying circuit full-wave rectifies the energy of the secondary coil to generate the output voltage. When the control circuit operates in the flyback mode, the rectifying circuit half-wave rectifies the energy of the secondary coil to generate the output voltage.

According to an embodiment of the present invention, when the control circuit operates in the resonant mode, the control circuit adjusts a voltage level of the output voltage by using a switching frequency of the high-side driving signal and the low-side driving signal. When the control circuit operates in the resonant mode, a duty cycle of the high-side driving signal and the low-side driving signal is close to 50%.

According to an embodiment of the present invention, when the control circuit operates in the flyback mode, the control circuit adjusts a voltage level of the output voltage by using a duty cycle of the high-side driving signal.

According to an embodiment of the present invention, the output voltage is equal to a product of the duty cycle of the high-side driving signal, a turns ratio of the transformer, and the input voltage. The turns ratio is equal to a number of turns of the secondary coil to a number of turns of the primary coil.

According to an embodiment of the present invention, the power conversion circuit further comprises a secondary control circuit. The secondary control circuit compares the output voltage to a reference voltage to generate the feedback signal and generating a mode signal. The control circuit generates the high-side driving signal and the low-side driving signal based on the feedback signal. The rectifying circuit full-wave or half-wave rectifies the energy of the secondary coil based on the mode signal.

According to an embodiment of the present invention, the secondary control circuit comprises a first comparator and an isolation circuit. The first comparator compares the output voltage to the reference voltage to generate a first comparison result. The isolation circuit generates the feedback signal based on the first comparison result.

According to an embodiment of the present invention, the secondary control circuit further comprises a second comparator and a mode control circuit. The second comparator compares the reference voltage to a threshold voltage to generate a second comparison result. The mode control circuit generates the mode signal based on the second comparison result. The isolation circuit further generates the feedback signal based on the mode signal.

According to an embodiment of the present invention, the control circuit further operates in either the resonant mode or the flyback mode based on the second comparison result. The rectifying circuit full-wave or half-wave rectifies the energy of the secondary coil based on the mode signal to generate the output voltage.

According to an embodiment of the present invention, when the reference voltage exceeds the threshold voltage, the rectifying circuit full-wave rectifies the energy of the secondary coil based on the mode signal to generate the output voltage, and the control circuit operates in the resonant mode. When the reference voltage does not exceed the threshold voltage, the rectifying circuit half-wave rectifies the energy of the secondary coil based on the mode signal to generate the output voltage, and the control circuit operates in the flyback mode.

According to an embodiment of the present invention, when the reference voltage does not exceed the threshold voltage, the threshold voltage is a first threshold voltage. When the reference voltage exceeds the first threshold voltage, the threshold voltage is a second threshold voltage. The first threshold voltage exceeds the second threshold voltage.

According to an embodiment of the present invention, the power conversion circuit is coupled to a load device. The reference voltage is adjusted based on the requirement of the load device.

According to an embodiment of the present invention, the secondary control circuit further comprises a mode control circuit. The mode control circuit generates a mode signal based on a mode requirement signal on a terminal of the secondary coil. The control circuit transmits a communication signal through the high-side driving signal during a high-side dead time or through the low-side driving signal during a low-side dead time. The communication signal is transmitted to the secondary coil through the transformer so that the mode requirement signal is generated at a terminal of the secondary coil. The rectifying circuit full-wave or half-wave rectifies the energy of the secondary coil based on the mode signal to generate the output voltage.

According to an embodiment of the present invention, when the control circuit determines that a switching frequency of the high-side driving signal and the low-side driving signal exceeds a predetermined frequency, the control circuit operates in the flyback mode and controls the rectifying circuit to perform a half-wave rectification through the communication signal. When the control circuit determines that a duty cycle of the high-side driving signal exceeds a predetermined duty cycle, the control circuit operates in the resonant mode and controls the rectifying circuit to perform a full-wave rectification through the communication signal.

According to an embodiment of the present invention, the secondary coil comprises a first terminal, a second terminal, and a common terminal. The rectifying circuit comprises an output capacitor, a first rectifying unit, a second rectifying unit, and a rectifying switch. The output capacitor is coupled between the output voltage and the ground, wherein the common terminal is coupled to the output voltage. The first rectifying unit us coupled between the first terminal and the ground. The second rectifying unit is coupled to the second terminal. The rectifying switch couples the second rectifying unit to the ground based on a mode signal. When the rectifying switch is turned on, the rectifying circuit full-wave rectifies the energy of the secondary coil. When the rectifying switch is turned off, the rectifying circuit half-wave rectifies the energy of the secondary coil.

In another embodiment, a control method for controlling a power conversion circuit to convert an input voltage into an output voltage is provided. The power conversion circuit comprises a resonant capacitor coupled between a resonant node and a ground, a transformer comprising a primary coil and a secondary coil, a high-side transistor providing the input voltage to a switch node, and a low-side transistor coupling the switch node to the ground. The primary coil is coupled between the switch node and the resonant node. The control method comprises the following steps. The output voltage is compared to a reference voltage to generate a feedback signal. The power conversion circuit is operated in either a resonant mode or a flyback mode. The high-side transistor and the low-side transistor are driven based on the feedback signal and either the resonant mode or the flyback mode. When the power conversion circuit is operated in the resonant mode, a rectifying circuit is utilized to full-wave rectify the energy of the secondary coil to generate the output voltage. When the power conversion circuit is operated in the flyback mode, the rectifying circuit is utilized to half-wave rectify the energy of the secondary coil to generate the output voltage.

According to an embodiment of the present invention, the step of operating the power conversion circuit in either the resonant mode or the flyback mode further comprises the following steps. It is determined whether the reference voltage exceeds a threshold voltage. When the reference voltage exceeds the threshold voltage, the power conversion circuit is operated in the resonant mode. When the reference voltage does not exceed the threshold voltage, the power conversion circuit is operated in the flyback mode.

According to an embodiment of the present invention, when the reference voltage does not exceed the threshold voltage, the threshold voltage is a first threshold voltage. When the reference voltage exceeds the threshold voltage, the threshold voltage is a second threshold voltage. The first threshold voltage exceeds the second threshold voltage.

According to an embodiment of the present invention, the step of operating the power conversion circuit in either the resonant mode or the flyback mode further comprises the following steps. When the power conversion circuit is operated in the resonant mode, it is determined whether a switching frequency of the high-side transistor and the low-side transistor exceeds a predetermined frequency. When the switching frequency exceeds the predetermined frequency, the power conversion circuit is operated in the flyback mode. When the switching frequency does not exceed the predetermined frequency, the power conversion circuit is kept in the resonant mode.

According to an embodiment of the present invention, the step of operating the power conversion circuit in either the resonant mode or the flyback mode further comprises the following steps. After the step of operating the power conversion circuit in the flyback mode when the switching frequency exceeds the predetermined frequency, a mode requirement signal is generated at a terminal of the secondary coil through the high-side transistor during a high-side dead time or through the low-side transistor during a low-side dead time. The rectifying circuit is controlled to perform a half-wave rectification based on the mode requirement signal.

According to an embodiment of the present invention, the step of operating the power conversion circuit in either the resonant mode or the flyback mode further comprises the following steps. When the power conversion circuit is operated in the flyback mode, it is determined whether a duty cycle of the high-side transistor exceeds a predetermined duty cycle. When the duty cycle exceeds the predetermined duty cycle, the power conversion circuit is operated in the resonant mode. When the duty cycle does not exceed the predetermined duty cycle, the power conversion circuit is kept in the flyback mode.

According to an embodiment of the present invention, the step of operating the power conversion circuit in either the resonant mode or the flyback mode further comprises the following steps. After the step of operating the power conversion circuit in the resonant mode when the duty cycle exceeds the predetermined duty cycle, a mode requirement signal is generated at a terminal of the secondary coil through the high-side transistor or the low-side transistor during a corresponding of high-side dead time or low-side dead time. The rectifying circuit is controlled to perform a full-wave rectification based on the mode requirement signal.

According to an embodiment of the present invention, the step of driving the high-side transistor and the low-side transistor based on the feedback signal and either the resonant mode or the flyback mode further comprises the following steps. When the power conversion circuit is operated in the flyback mode, a duty cycle of the high-side driving signal is utilized to adjust a voltage level of the output voltage. When the power conversion circuit is operated in the resonant mode, a switching frequency of the high-side transistor and the low-side transistor is utilized to adjust the voltage level of the output voltage. The high-side transistor and the low-side transistor are driven so that the output voltage is close to the reference voltage.

According to an embodiment of the present invention, the secondary coil comprises a first terminal, a second terminal, and a common terminal. The rectifying circuit comprises a first rectifying unit coupled between the first terminal and the ground, a second rectifying unit coupled to the second terminal, and a rectifying switch coupling the second rectifying unit to the ground. When the energy of the second coil is full-wave rectified to generate the output voltage, the rectifying switch is turned on. When the energy of the second coil is half-wave rectified to generate the output voltage, the rectifying switch is turned off.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram showing a power conversion circuit in accordance with an embodiment of the present invention;

FIG. 2 is a block diagram showing a secondary control circuit in accordance with an embodiment of the present invention;

FIG. 3 is a block diagram showing a power conversion circuit in accordance with another embodiment of the present invention;

FIG. 4 is a timing diagram showing a communication signal generated by a control circuit in accordance with an embodiment of the present invention;

FIG. 5 is a block diagram showing a secondary control circuit in accordance with another embodiment of the present invention;

FIG. 6 is a schematic diagram showing a time-to-voltage conversion circuit in accordance with an embodiment of the present invention;

FIG. 7 is a block diagram showing a power system in accordance with an embodiment of the present invention; and

FIG. 8 is a flow chart showing a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

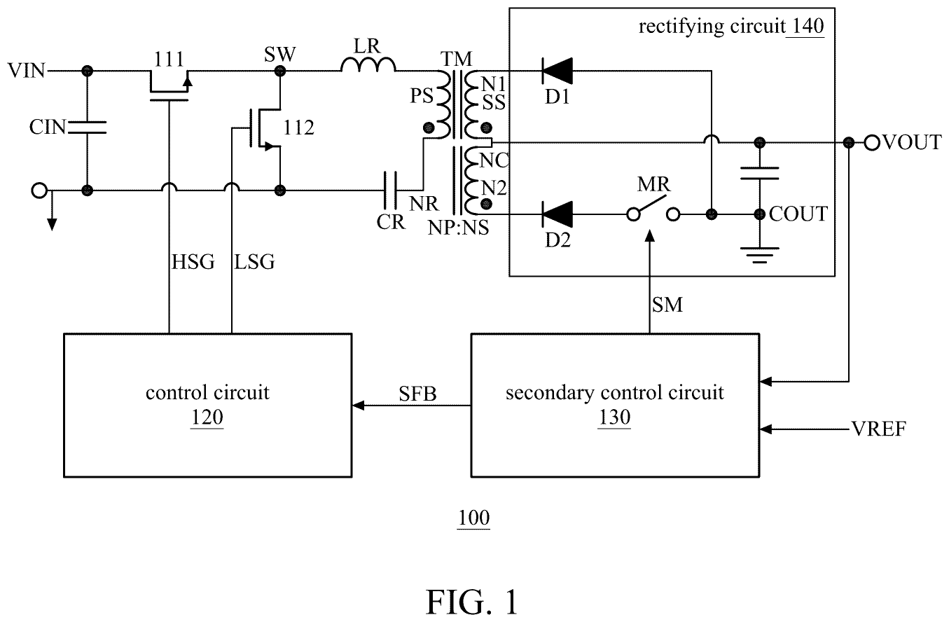

FIG. 1 is a block diagram showing a power conversion circuit in accordance with an embodiment of the present invention. As shown in FIG. 1, the power conversion circuit 100 is configured to convert the input voltage VIN into the output voltage VOUT, and includes a transformer TM, a resonant inductor LR, a resonant capacitor CR, an input capacitor CIN, an high-side transistor 111, a low-side transistor 112, a control circuit 120, a secondary control circuit 130, and a rectifying circuit 140.

The transformer TM includes a primary coil PS and a secondary coil SS. The primary coil PS is coupled to the resonant node NR, the primary coil PS has a first number of turns NP, and the secondary coil SS has a second number of turns NS. The resonant inductor LR is coupled between the switch node SW and the primary coil PS, and the resonant capacitor CR is coupled between the resonant node NR and the ground. According to an embodiment of the present invention, the resonant inductor LR can be replaced by the leakage inductance of the primary coil PS of the transformer TM. In other words, the primary coil PS may be coupled between the switching node SW and the resonant node NR.

As shown in FIG. 1, the input capacitor CIN is coupled between the input voltage VIN and the ground. The high-side driving signal HSG drives the high-side transistor 111 to be turned on or turned off, thereby providing the input voltage VIN to the switching node SW. The low-side driving signal LSG drives the low-side transistor 112 to be turned on or turned off, thereby coupling the switching node SW to the ground.

The control circuit 120 operates in either one of the flyback mode and the resonant mode, and generates the high-side driving signal HSG and the low-side driving signal LSG based on the feedback signal SFB. According to an embodiment of the present invention, when the control circuit 120 operates in the resonant mode, the control circuit 120 uses the switching frequency of the high-side driving signal HSG and the low-side driving signal LSG to adjust the voltage level of the output voltage VOUT. When the control circuit 120 operates in the resonant mode, the duty cycles of the high-side driving signal HSG and the lower-bridge driving signal LSG are both close to 50%.

According to another embodiment of the present invention, when the control circuit 120 operates in the flyback mode, the control circuit 120 uses the duty cycle of the high-side driving signal HSG to adjust the voltage level of the output voltage VOUT, where Eq. 1 shows the duty cycle D of the high-side driving signal HSG (that is, the on time TON divided by the sum of the on time TON and the off time TOFF), the output voltage VOUT, and the number of turns ratio (that is, the second number of turns NS of the secondary coil SS divided by the first number of turns NP of the primary coil PS), and the input voltage VIN. In other words, the output voltage VOUT is equal to the product of the duty cycle D of the high-side driving signal HSG, the turns ratio (i.e., the second number of turns NS divided by the first number of turns NP), and the input voltage VIN.

$$D = \frac{T ON}{T ON + T OFF} = \frac{VOUT}{VIN \times \frac{NS}{NP}}$$

The secondary control circuit 130 compares the output voltage VOUT with the reference voltage VREF to generate the feedback signal SFB, and the secondary control circuit 130 generates the mode signal SM. The control circuit 120 generates a high-side driving signal HSG and a low-side driving signal LSG based on the feedback signal SFB to make the output voltage VOUT close to the reference voltage VREF.

The rectifying circuit 140 is coupled to the secondary coil SS for converting the energy of the secondary coil SS into the output voltage VOUT. As shown in FIG. 1, the rectifying circuit 140 includes an output capacitor COUT, a first rectifying unit D1, a second rectifying unit D2, and a rectifying switch MR. The secondary coil SS includes a first terminal N1, a second terminal N2, and a common terminal NC. The output capacitor COUT is coupled to the output voltage VOUT and the ground, and the common terminal NC is coupled to the output voltage VOUT.

The first rectifying element D1 is coupled between the first terminal N1 and the ground, and the second rectifying element D2 is coupled to the second terminal N2. The rectifying switch MR couples the second rectifying unit D2 to the ground based on the mode signal SM. According to an embodiment of the present invention, when the rectifying switch MR is turned on based on the mode signal SM, the rectifying circuit 140 full-wave rectifies the energy of the secondary coil SS to generate the output voltage VOUT. According to another embodiment of the present invention, when the rectifying switch MR is not turned on based on the mode signal SM, the rectifying circuit 140 half-wave rectifies the energy of the secondary coil SS to generate the output voltage VOUT.

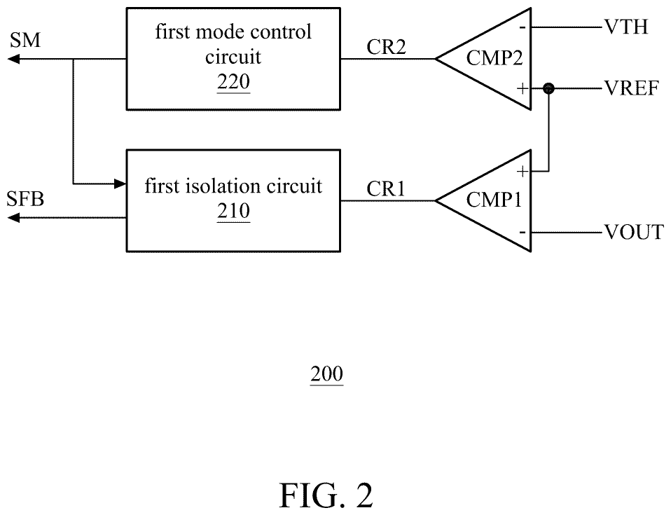

FIG. 2 is a block diagram showing a secondary control circuit in accordance with an embodiment of the present invention. According to an embodiment of the present invention, the secondary control circuit 200 corresponds to the secondary control circuit 130 in FIG. 1. As shown in FIG. 2, the secondary control circuit 200 includes a first comparator CMP1, a first isolation circuit 210, a second comparator CMP2 and a first mode control circuit 220.

The first comparator CMP1 compares the output voltage VOUT in FIG. 1 with the reference voltage VREF to generate a first comparison result CR1. The first isolation circuit 210 generates the feedback signal SFB based on the first comparison result CR1. The second comparator CMP2 compares the reference voltage VREF with the threshold voltage VTH to generate a second comparison result CR2. The first mode control circuit 220 generates the mode signal SM based on the second comparison result CR2, and the first isolation circuit 210 further generates the feedback signal SFB based on the mode signal SM.

In other words, the first isolation circuit 210 generates the feedback signal SFB based on the mode signal SM and the first comparison result CR1. The control circuit 120 in FIG. 1 operates in one of the flyback mode and the resonant mode based on the mode signal SM of the feedback signal SFB. The rectifying circuit 140 in FIG. 1 is based on the mode signal SM generated by the first mode control circuit 220. The full-wave or half-wave rectifies the energy of the secondary coil SS to generate the output voltage VOUT.

According to an embodiment of the present invention, when the reference voltage VREF exceeds the threshold value VTH, the rectifying switch MR in FIG. 1 is turned on based on the mode signal SM, so that the rectifying circuit 140 full-wave rectifies the energy of the secondary coil SS to generate the output voltage VOUT. Moreover, the control circuit 120 further operates in the resonant mode based on the mode signal SM of the feedback signal SFB. In other words, when the reference voltage VREF exceeds the threshold value VTH, the secondary control circuit 200 notifies the control circuit 120 to operate in the resonant mode through the feedback signal SFB, and controls the rectifying circuit 140 to perform full-wave rectification. Therefore, the control circuit 120 changes the voltage level of the output voltage VOUT by adjusting the switching frequency.

According to another embodiment of the present invention, when the reference voltage VREF does not exceed the threshold value VTH, the rectifying switch MR in FIG. 1 is turned off based on the mode signal SM, so that the rectifying circuit 140 half-wave rectifies the energy of the secondary coil SS to generate the output voltage VOUT. Moreover, the control circuit 120 further operates in the flyback mode based on the mode signal SM of the feedback signal SFB. In other words, when the reference voltage VREF does not exceed the threshold value VTH, the secondary control circuit 200 notifies the control circuit 120 to operate in the flyback mode through the feedback signal SFB, and controls the rectifying circuit 140 to perform half-wave rectification. Therefore, the control circuit 120 changes the voltage level of the output voltage VOUT by adjusting the duty cycle of the high-side driving signal HSG.

According to some embodiments of the present invention, when the reference voltage VREF does not exceed the threshold voltage VTH, the threshold voltage VTH is the first threshold voltage. When the reference voltage VREF exceeds the threshold voltage VTH, the threshold voltage VTH is the second threshold voltage. Moreover, the first threshold voltage exceeds the second threshold voltage. In other words, when the reference voltage VREF exceeds the threshold voltage VTH, the threshold voltage VTH is reduced to avoid frequent switching of the second comparison result CR2. According to other embodiments of the present invention, the first threshold voltage may also be equal to the second threshold voltage.

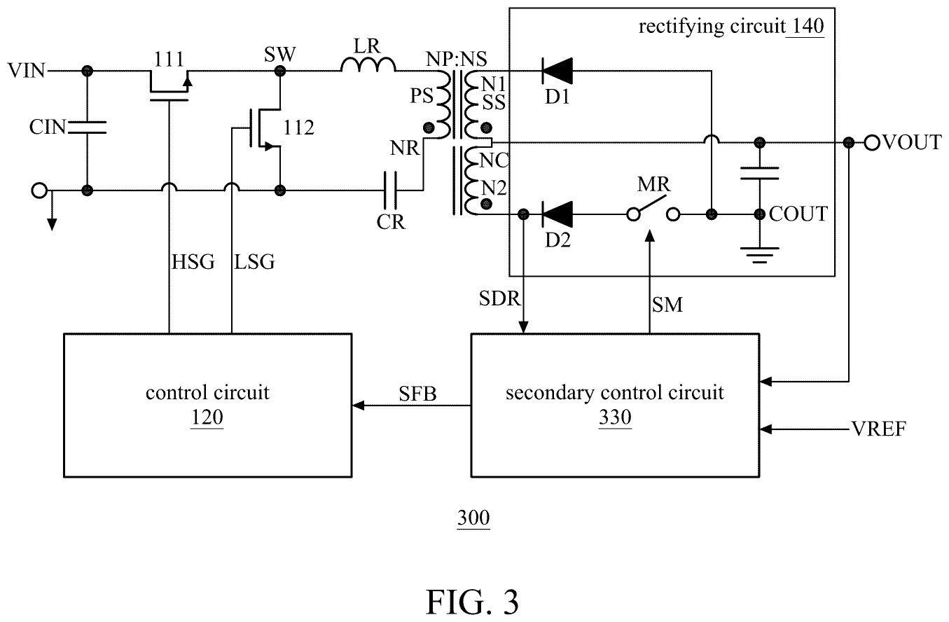

FIG. 3 is a block diagram showing a power conversion circuit in accordance with another embodiment of the present invention. Comparing the power conversion circuit 300 with the power conversion circuit 100 in FIG. 1, the secondary control circuit 130 in FIG. 1 is replaced by a secondary control circuit 330, and the secondary control circuit 330 receives the mode requirement signal SDR of the second node N2 to generate the mode signal SM. The rectifying circuit 140 full-wave or half-wave rectifies the energy of the secondary coil SS based on the mode signal SM to generate the output voltage VOUT.

According to another embodiment of the present invention, the secondary control circuit 330 may also receive the mode requirement signal SDR at the first node N1. The explanation herein is based on receiving the mode requirement signal SDR of the second node N2, but not intended to be limited thereof.

According to another embodiment of the present invention, the control circuit 120 in FIG. 3 monitors the switching frequency of the high-side driving signal HSG and the low-side driving signal LSG and the duty cycle of the high-side driving signal HSG, and generates the mode requirement signal SDR at the second node N2 during the high-side dead time or the low-side dead time by transmitting a communication signal through the corresponding high-side driving signal HSG or low-side driving signal LSG and the transformer TM, so as to turn on or off the rectifier transistor MR.

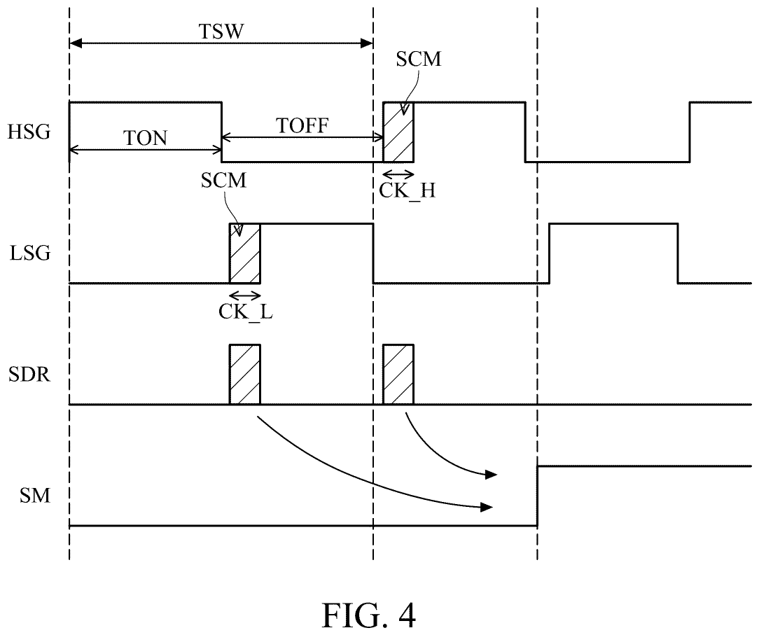

FIG. 4 is a timing diagram showing a communication signal generated by a control circuit in accordance with an embodiment of the present invention. As shown in FIG. 4, the period that the high-side driving signal HSG turns on the high-side transistor 111 is defined as the on TON, and the period that the high-side driving signal HSG turns off the high-side transistor 111 is defined as the off time TOFF. The rising edge of the high-side driving signal HSG to the rising edge of the low-side driving signal LSG is the switching period TSW.

As shown in FIG. 4, the control circuit 120 of FIG. 3 generates the communication signal SCM on the low-side driving signal LSG during the low-side dead time CK_L (or, generates the communication signal SCM on the high-side driving signal HSG during the high-side dead time CK_H), and generates the mode requirement signal SDR at the second node N2 of the secondary coil SS through the transformer TM. After the secondary control circuit 330 receives the mode requirement signal SDR, the secondary control circuit 330 generates the corresponding mode signal SM in the next driving cycle (in this embodiment, after the falling edge of the high-side driving signal HSG).

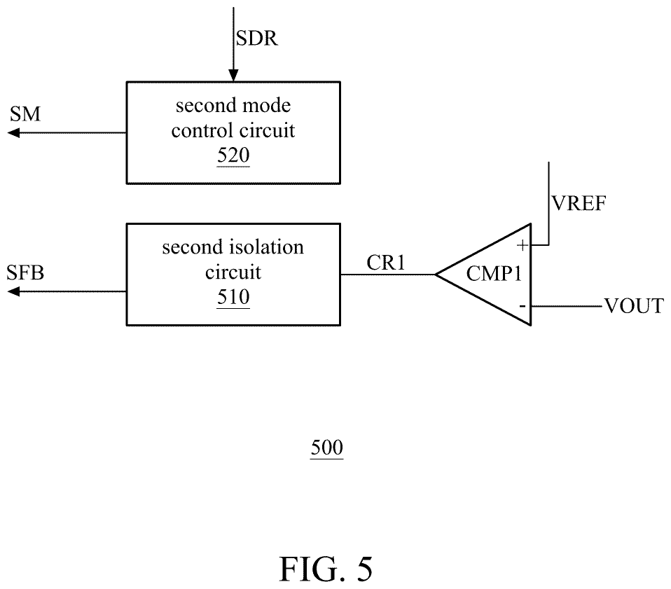

FIG. 5 is a block diagram showing a secondary control circuit in accordance with another embodiment of the present invention. Comparing the secondary control circuit 500 with the secondary control circuit 200 in FIG. 2, the secondary control circuit 500 omits the second comparator CMP2 of the secondary control circuit 200, and the first isolation circuit 210 and the first mode control circuit 220 is replaced by a second isolation circuit 510 and a second mode control circuit 520 respectively.

As shown in FIG. 5, the second isolation circuit 510 generates the feedback signal SFB based only on the first comparison result CR1, and the second mode control circuit 520 generates the mode signal SM based on the mode requirement signal SDR of the second node N2 to control the rectifying switch MR in FIG. 3 to be turned on or turned off.

According to an embodiment of the present invention, when the control circuit 120 in FIG. 3 operates in the resonant mode and detects that the switching frequency exceeds a predetermined frequency, the control circuit 120 generates the mode requirement signal SDR on the high-side driving signal HSG (or the low-side driving signal LSG) to control the rectifying circuit 140 to perform the half-wave rectification through the transformer TM, and the control circuit 120 then switches from the resonant mode to the flyback mode.

According to another embodiment of the present invention, when the control circuit 120 operates in the flyback mode and detects that the duty cycle of the high-side driving signal HSG exceeds the predetermined duty cycle, the control circuit 120 generates the mode requirement signal SDR on the high-side driving signal HSG (or the low-side driving signal LSG) to control the rectifying circuit 140 to perform the full-wave rectification through the transformer TM, and the control circuit 120 then switches from the flyback mode to the resonant mode.

According to an embodiment of the present invention, the control circuit 120 in FIG. 3 may use a counter to count the switching period TSW in FIG. 4, where the reciprocal of the switching period TSW is the switching frequency of the high-side driving signal HSG and the low-side driving signal LSG. According to an embodiment of the present invention, the control circuit 120 in FIG. 3 uses a counter to count the on time TON of the high-side driving signal HSG in FIG. 4, and determines the duty cycle of the high-side driving signal HSG.

According to another embodiment of the present invention, the control circuit 120 in FIG. 3 can use a time-to-voltage conversion circuit to convert the switching period TSW in FIG. 4 into a periodic voltage, and convert the on time TON of the high-side driving signal HSG in FIG. 4 into a conduction voltage. When the periodic voltage is lower than the first threshold voltage, it means that the switching frequency exceeds the predetermined frequency; when the conduction voltage exceeds the second threshold voltage, it means that the duty cycle of the high-side driving signal HSG exceeds the predetermined duty cycle.

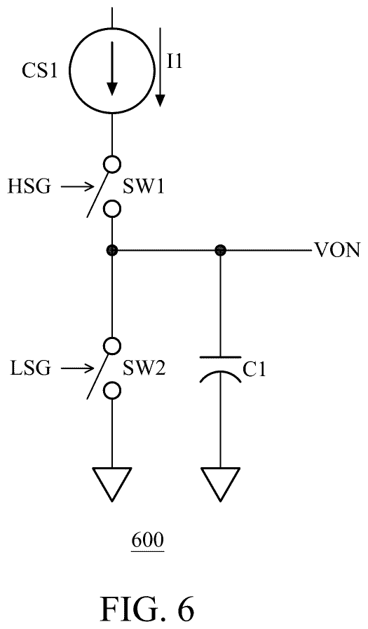

FIG. 6 is a schematic diagram showing a time-to-voltage conversion circuit in accordance with an embodiment of the present invention. As shown in FIG. 6, the time-to-voltage conversion circuit 600 includes a first current source CS1, a first switch SW1, a second switch SW2, and a first capacitor C1. The first current source CS1 provides the first current I1, and the first switch SW1 provides the first current I1 to the first capacitor C1 based on the high-side driving signal HSG, so that the first current I1 charges the first capacitor C1 to generate the conduction voltage VON. The second switch SW2 discharges the first capacitor C1 based on the low-side driving signal LSG.

In other words, when the high-side transistor 111 in FIG. 3 is turned on, the first current I1 charges the first capacitor C1; when the low-side transistor 112 in FIG. 3 is turned on, the second switch SW2 discharges the first capacitor C1. Therefore, during the high-side dead time, the control circuit 120 can determine whether the duty cycle of the high-side driving signal HSG exceeds the predetermined duty cycle based on the conduction voltage VON. According to other embodiments of the present invention, the switching frequency can be converted into a corresponding voltage using the time-to-voltage conversion circuit 600, and then it can be determined whether the switching frequency exceeds a predetermined frequency.

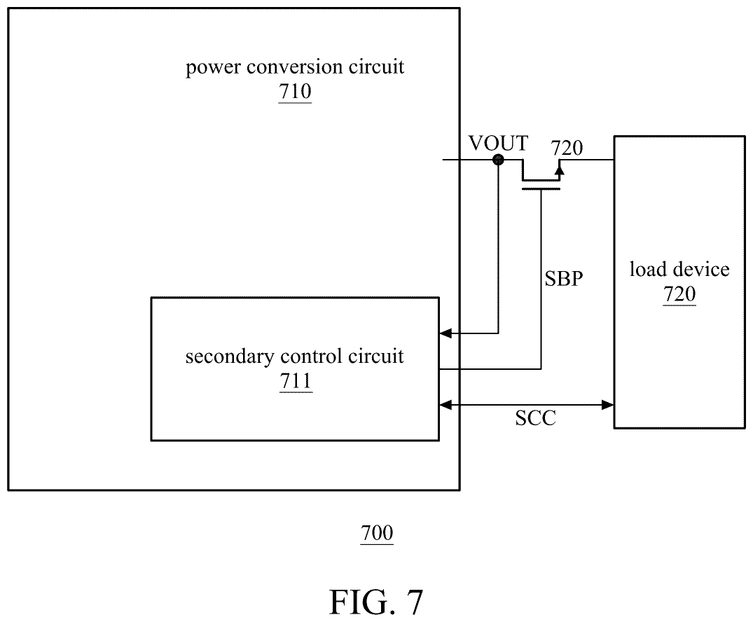

FIG. 7 is a block diagram showing a power system in accordance with an embodiment of the present invention. As shown in FIG. 7, the power system 700 includes a power conversion circuit 710, a load device 720, and a load switch 730. The power conversion circuit 710 includes a secondary control circuit 711. According to an embodiment of the present invention, the power conversion circuit 710 corresponds to the power conversion circuit 100 in FIG. 1, and the secondary control circuit 711 corresponds to the secondary control circuit 130 in FIG. 1. According to another embodiment of the present invention, the power conversion circuit 710 corresponds to the power conversion circuit 300 in FIG. 3, and the secondary control circuit 711 corresponds to the secondary control circuit 330 in FIG. 3.

The load device 720 provides the required voltage level of the output voltage VOUT to the secondary control circuit 711 of the power conversion circuit 710 through the handover signal SCC. According to an embodiment of the present invention, the secondary control circuit 711 determines the reference voltage VREF of FIG. 1 and FIG. 3 based on the handshake signal SCC. For example, when the load device 720 notifies the power conversion circuit 710 that 20V of the output voltage VOUT is required through the handshake signal SCC, the secondary control circuit 711 sets the reference voltage VREF to 20V. In other words, the reference voltage VREF is adjusted based on the requirement of the load device 720.

The load switch 730 is coupled between the output voltage VOUT and the load device 720. When the secondary control circuit 711 determines that the output voltage VOUT is very close to the reference voltage VREF, the secondary control circuit 711 uses the load signal SBP to turn on the load switch 730 to provide the output voltage VOUT to the load device 720.

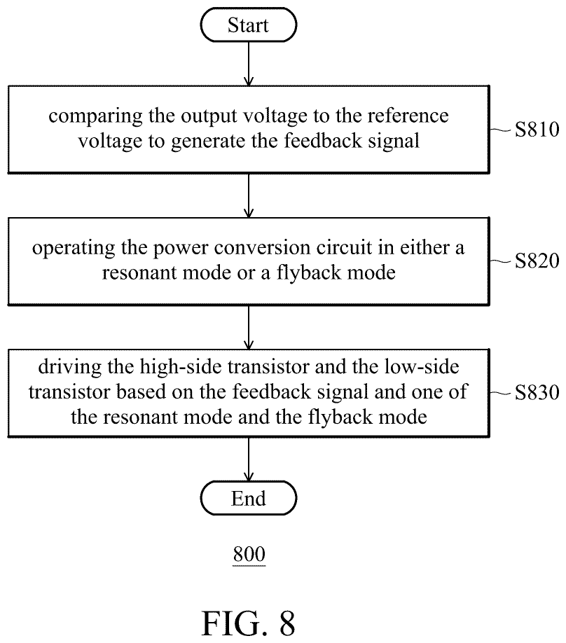

FIG. 8 is a flow chart showing a control method in accordance with an embodiment of the present invention. The following description of the control method 800 in FIG. 8 will be combined with the power conversion circuit 100 in FIG. 1 to facilitate detailed description, but not intended to be limited thereto. The control method 800 is also applicable to the power conversion circuit 300 in FIG. 3.

First, the secondary control circuit 130 is utilized to compare the output voltage VOUT to the reference voltage VREF to generate the feedback signal SFB (Step S810). Next, the power conversion circuit 100 is operated in either one of the resonant mode and the flyback mode (Step S820). Subsequently, based on the feedback signal SFB and one of the resonant mode and the flyback mode, the high-side transistor 111 and the low-side transistor 112 are driven (Step S830).

According to an embodiment of the present invention, when the power conversion circuit 100 operates in the resonant mode, the switching frequency of the high-side driving signal HSG and the low-side driving signal LSG is utilized to adjust the voltage level of the output voltage VOUT, and the rectifying circuit 140 is controlled to full-wave rectify the energy of the secondary coil SS to generate the output voltage VOUT. According to another embodiment of the present invention, when the power conversion circuit 100 operates in the flyback mode, the duty cycle of the high-side driving signal HSG is utilized to adjust the voltage level of the output voltage VOUT, and the rectifying circuit 140 is controlled to half-wave rectify the energy of the secondary coil SS to generate the output voltage VOUT.

A power conversion circuit and a control method thereof have been proposed herein, so that the power conversion circuit automatically switches between the resonant mode and the flyback mode. When the power conversion circuit operates in the resonant mode and determines that the switching frequency exceeds a predetermined frequency, the power conversion circuit switches to the flyback mode to reduce the switching frequency, so as to obtain higher conversion efficiency. When the power conversion circuit operates in the flyback mode and determines that the duty cycle of the high-side transistor exceeds the predetermined duty cycle, the power conversion circuit switches to the resonant mode to provide greater output power. Therefore, the power conversion circuit and the control method thereof proposed herein can not only provide a wide range of output voltage and high output power, but also maintain high conversion efficiency at light load and low output voltage, helping to meet market demand.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit converting an input voltage into an output voltage, comprising:
a resonant capacitor, coupled between a resonant node and a ground;
a transformer, comprising a primary coil and a secondary coil, wherein the primary coil is coupled between a switch node and the resonant node;
a high-side transistor, providing the input voltage to the switch node based on a high-side driving signal;
a low-side transistor, coupling the switch node to the ground based on a low-side driving signal;
a control circuit, operating in either a flyback mode or a resonant mode to generate the high-side driving signal and the low-side driving signal; and
a rectifying circuit, converting energy of the secondary coil into the output voltage;
wherein when the control circuit operates in the resonant mode, the rectifying circuit full-wave rectifies the energy of the secondary coil to generate the output voltage;
wherein when the control circuit operates in the flyback mode, the rectifying circuit half-wave rectifies the energy of the secondary coil to generate the output voltage.

2. The power conversion circuit as claimed in claim 1, wherein when the control circuit operates in the resonant mode, the control circuit adjusts a voltage level of the output voltage by using a switching frequency of the high-side driving signal and the low-side driving signal;
wherein when the control circuit operates in the resonant mode, a duty cycle of the high-side driving signal and the low-side driving signal is close to 50%.

3. The power conversion circuit as claimed in claim 1, wherein when the control circuit operates in the flyback mode, the control circuit adjusts a voltage level of the output voltage by using a duty cycle of the high-side driving signal.

4. The power conversion circuit as claimed in claim 3, wherein the output voltage is equal to a product of the duty cycle of the high-side driving signal, a turns ratio of the transformer, and the input voltage;
wherein the turns ratio is equal to a number of turns of the secondary coil to a number of turns of the primary coil.

5. The power conversion circuit as claimed in claim 1, further comprising:
a secondary control circuit, comparing the output voltage to a reference voltage to generate the feedback signal and generating a mode signal;
wherein the control circuit generates the high-side driving signal and the low-side driving signal based on the feedback signal;
wherein the rectifying circuit full-wave or half-wave rectifies the energy of the secondary coil based on the mode signal.

6. The power conversion circuit as claimed in claim 5, wherein the secondary control circuit comprises:
a first comparator, comparing the output voltage to the reference voltage to generate a first comparison result; and
an isolation circuit, generating the feedback signal based on the first comparison result.

7. The power conversion circuit as claimed in claim 6, wherein the secondary control circuit further comprises:
a second comparator, comparing the reference voltage to a threshold voltage to generate a second comparison result; and
a mode control circuit, generating the mode signal based on the second comparison result;
wherein the isolation circuit further generates the feedback signal based on the mode signal.

8. The power conversion circuit as claimed in claim 7, wherein the control circuit further operates in either the resonant mode or the flyback mode based on the second comparison result;
wherein the rectifying circuit full-wave or half-wave rectifies the energy of the secondary coil based on the mode signal to generate the output voltage.

9. The power conversion circuit as claimed in claim 8, wherein when the reference voltage exceeds the threshold voltage, the rectifying circuit full-wave rectifies the energy of the secondary coil based on the mode signal to generate the output voltage, and the control circuit operates in the resonant mode;
wherein when the reference voltage does not exceed the threshold voltage, the rectifying circuit half-wave rectifies the energy of the secondary coil based on the mode signal to generate the output voltage, and the control circuit operates in the flyback mode.

10. The power conversion circuit as claimed in claim 8, wherein when the reference voltage does not exceed the threshold voltage, the threshold voltage is a first threshold voltage;
wherein when the reference voltage exceeds the first threshold voltage, the threshold voltage is a second threshold voltage;
wherein the first threshold voltage exceeds the second threshold voltage.

11. The power conversion circuit as claimed in claim 8, wherein the power conversion circuit is coupled to a load device;
wherein the reference voltage is adjusted based on the requirement of the load device.

12. The power conversion circuit as claimed in claim 6, wherein the secondary control circuit further comprises:
a mode control circuit, generating a mode signal based on a mode requirement signal on a terminal of the secondary coil;
wherein the control circuit transmits a communication signal through the high-side driving signal a high-side dead time or through the low-side driving signal during a low-side dead time;
wherein the communication signal is transmitted to the secondary coil through the transformer so that the mode requirement signal is generated at a terminal of the secondary coil;
wherein the rectifying circuit full-wave or half-wave rectifies the energy of the secondary coil based on the mode signal to generate the output voltage.

13. The power conversion circuit as claimed in claim 12, wherein when the control circuit determines that a switching frequency of the high-side driving signal and the low-side driving signal exceeds a predetermined frequency, the control circuit operates in the flyback mode and controls the rectifying circuit to perform a half-wave rectification through the communication signal;
wherein when the control circuit determines that a duty cycle of the high-side driving signal exceeds a predetermined duty cycle, the control circuit operates in the resonant mode and controls the rectifying circuit to perform a full-wave rectification through the communication signal.

14. The power conversion circuit as claimed in claim 12, wherein the secondary coil comprises a first terminal, a second terminal, and a common terminal;
wherein the rectifying circuit comprises:
an output capacitor, coupled between the output voltage and the ground, wherein the common terminal is coupled to the output voltage;
a first rectifying unit, coupled between the first terminal and the ground;
a second rectifying unit, coupled to the second terminal; and
a rectifying switch, coupling the second rectifying unit to the ground based on a mode signal;
wherein when the rectifying switch is turned on, the rectifying circuit full-wave rectifies the energy of the secondary coil;
wherein when the rectifying switch is turned off, the rectifying circuit half-wave rectifies the energy of the secondary coil.

15. A control method for controlling a power conversion circuit to convert an input voltage into an output voltage, wherein the power conversion circuit comprises a resonant capacitor coupled between a resonant node and a ground, a transformer comprising a primary coil and a secondary coil, a high-side transistor providing the input voltage to a switch node, and a low-side transistor coupling the switch node to the ground, wherein the primary coil is coupled between the switch node and the resonant node, wherein the control method comprises:
comparing the output voltage to a reference voltage to generate a feedback signal;
operating the power conversion circuit in either a resonant mode or a flyback mode; and
driving the high-side transistor and the low-side transistor based on the feedback signal and either the resonant mode or the flyback mode;
wherein when the power conversion circuit is operated in the resonant mode, a rectifying circuit is utilized to full-wave rectify the energy of the secondary coil to generate the output voltage;
wherein when the power conversion circuit is operated in the flyback mode, the rectifying circuit is utilized to half-wave rectify the energy of the secondary coil to generate the output voltage.

16. The control method as claimed in claim 15, wherein the step of operating the power conversion circuit in either the resonant mode or the flyback mode further comprises:
determining whether the reference voltage exceeds a threshold voltage;
when the reference voltage exceeds the threshold voltage, operating the power conversion circuit in the resonant mode; and
when the reference voltage does not exceed the threshold voltage, operating the power conversion circuit in the flyback mode.

17. The control method as claimed in claim 16, wherein when the reference voltage does not exceed the threshold voltage, the threshold voltage is a first threshold voltage;
wherein when the reference voltage exceeds the threshold voltage, the threshold voltage is a second threshold voltage;
wherein the first threshold voltage exceeds the second threshold voltage.

18. The control method as claimed in claim 15, wherein the step of operating the power conversion circuit in either the resonant mode or the flyback mode further comprises:
when the power conversion circuit is operated in the resonant mode, determining whether a switching frequency of the high-side transistor and the low-side transistor exceeds a predetermined frequency;
when the switching frequency exceeds the predetermined frequency, operating the power conversion circuit in the flyback mode; and
when the switching frequency does not exceed the predetermined frequency, keeping the power conversion circuit in the resonant mode.

19. The control method as claimed in claim 18, wherein the step of operating the power conversion circuit in either the resonant mode or the flyback mode further comprises:
after the step of operating the power conversion circuit in the flyback mode when the switching frequency exceeds the predetermined frequency, generating a mode requirement signal at a terminal of the secondary coil through the high-side transistor during a high-side dead time or through the low-side transistor during a low-side dead time; and
controlling the rectifying circuit to perform a half-wave rectification based on the mode requirement signal.

20. The control method as claimed in claim 15, wherein the step of operating the power conversion circuit in either the resonant mode or the flyback mode further comprises:
when the power conversion circuit is operated in the flyback mode, determining whether a duty cycle of the high-side transistor exceeds a predetermined duty cycle;
when the duty cycle exceeds the predetermined duty cycle, operating the power conversion circuit in the resonant mode; and
when the duty cycle does not exceed the predetermined duty cycle, keeping the power conversion circuit in the flyback mode.

21. The control method as claimed in claim 20, wherein the step of operating the power conversion circuit in either the resonant mode or the flyback mode further comprises:
after the step of operating the power conversion circuit in the resonant mode when the duty cycle exceeds the predetermined duty cycle, generating a mode requirement signal at a terminal of the secondary coil through the high-side transistor during a high-side dead time or through the low-side transistor during a low-side dead time; and
controlling the rectifying circuit to perform a full-wave rectification based on the mode requirement signal.

22. The control method as claimed in claim 15, wherein the step of driving the high-side transistor and the low-side transistor based on the feedback signal and either the resonant mode or the flyback mode further comprises:
when the power conversion circuit is operated in the flyback mode, utilizing a duty cycle of the high-side driving signal to adjust a voltage level of the output voltage;
when the power conversion circuit is operated in the resonant mode, utilizing a switching frequency of the high-side transistor and the low-side transistor to adjust the voltage level of the output voltage; and
driving the high-side transistor and the low-side transistor so that the output voltage is close to the reference voltage.

23. The control method as claimed in claim 15, wherein the secondary coil comprises a first terminal, a second terminal, and a common terminal;
wherein the rectifying circuit comprises a first rectifying unit coupled between the first terminal and the ground, a second rectifying unit coupled to the second terminal, and a rectifying switch coupling the second rectifying unit to the ground;
wherein when the energy of the second coil is full-wave rectified to generate the output voltage, the rectifying switch is turned on;
wherein when the energy of the second coil is half-wave rectified to generate the output voltage, the rectifying switch is turned off.
